(19) United States
(12) Patent Application Publication
(10) Pub. No.: US 2023/0074074 A1
(43) Pub. Date: Mar. 9, 2023

(54) INTELLIGENT RECOGNITION METHOD FOR WHILE-DRILLING SAFETY RISK BASED ON CONVOLUTIONAL NEURAL NETWORK

(71) Applicant: Southwest Petroleum University, Chengdu City (CN)

(72) Inventors: Wenhe XIA, Chengdu City (CN); Wanjun HU, Chengdu City (CN); Gao LI, Chengdu City (CN); Yongjie LI, Chengdu City (CN); Jun JIANG, Chengdu City (CN); Xiangdong CHEN, Chengdu City (CN)

(21) Appl. No.: 17/543,426

(22) Filed: Dec. 6, 2021

(30) Foreign Application Priority Data
Sep. 2, 2021 (CN) 2021110279641

(51) Int. Cl. E21B 44/00; G06N 3/08; E21B 49/00

(52) U.S. Cl. CPC E21B 44/00; G06N 3/088; G06N 3/084; E21B 49/003; E21B 2200/22

(57) ABSTRACT

The present invention discloses an intelligent recognition method for while-drilling safety risks based on a convolutional neural network. The method includes the following steps: 1, processing while-drilling safety risk parameter features and data, and establishing a correlation analysis model for monitoring-while-drilling parameters by using a Pearson coefficient correlation analysis method; 2, processing while-drilling safety monitoring data, analyzing a time span of each sample, constructing training sample data and test sample data, and preprocessing the samples; 3, designing a while-drilling safety risk recognition network structure; and 4, recognizing while-drilling safety risks by the trained safety risk recognition network. The method of the present invention is applied to monitoring-while-drilling engineering, which can greatly improve the drilling efficiency and a reservoir drilling rate, reduce a complex accident rate and cost in drilling, provide a powerful safety guarantee for drilling work, meet the current urgent demands for cost reduction and efficiency enhancement in drilling to a certain extent, and also provide a new idea for the development of intelligent drilling technologies in China.

### TECHNICAL FIELD

The present invention relates to the field of downhole safety while drilling, and more particularly to an intelligent recognition method for while-drilling safety risks based on a convolutional neural network.

### BACKGROUND ART

Drilling is very complex downhole engineering. The influences of many factors, such as geological conditions, engineering conditions, and manual operations, poses major challenges to the efficiency, safety, and quality of drilling engineering. Therefore, how to recognize and accordingly deal with safety risks while drilling, such as sticking, gas production, borehole instability and drill tool fracture, in a timely manner under complex site conditions, and to prevent large-scale accidents, is a key part of improving the success rate of drilling and completion and reducing the cost of drilling and completion. In the current drilling process, the most common judgment method is to empirically observe and while-drilling safety risks by on-site monitoring personnel in real time according to working conditions of various instruments and various collected downhole parameters. The way of artificial recognition has higher requirements on the professional knowledge level of the on-site monitoring personnel, and makes judgment results have strong subjectivity and time latency. At the same time, due to factors such as geological conditions and artificial operations, different wells have different characteristics when safety risks occur, which further increases the difficulty in on-site artificial monitoring.

In recent years, with the rapid development of artificial intelligence technologies on a global scale, the intelligentization of oil and gas exploration and development has become a hot spot in the development of the oil and gas industry on the global scale. The oil and gas industry in China has also begun to promote the development of intelligent drilling. The integration of advanced theories and technologies such as big data and artificial intelligence is expected to greatly increase the production and recovery rate of complex oil and gas and reduce the drilling and completion cost, and thus becomes a transformative technology to ensure the security of energy strategies in China.

Since 2015, Li Gao, Meng Yingfeng, et al., in Southwest Petroleum University have established a relationship model between the occurrence of main risks such as borehole instability, water production, gas production, downhole explosion and drill string failure and corresponding parameter changes during the gas drilling process. Furthermore, based on the existing ground monitoring technologies, an effective gas while-drilling safety risk recognition method has been formed. In 2017, Qiu Shaolin, Zhang Laibin, et al., analyzed 7 factors affecting downhole accident risks, such as drilling fluid density, rheology, fluid loss, and rock type. Through the establishment of a downhole accident risk assessment index system, the fuzzy comprehensive quantitative assessment of downhole accident risks was implemented. Also in 2017, Guan Zhichuan, et al., in China University of Petroleum proposed a BP neural network drilling risk assessment method based on a particle swarm algorithm. In 2019, Sheng Yanan, Guan Zhichuan, et al., proposed a quantitative evaluation method for drilling engineering risks based on uncertainty analysis. In 2020, Wang Qian, et al., proposed recognition of downhole safety risks based on the combination of drilling models and expert systems. In summary, the drilling technology is constantly evolving from traditional drilling to intelligent drilling that combines machine learning and artificial intelligence. However, due to high complexity of drilling safety risks and limited historical data, the effect of network training is not good. Therefore, the current research results are still mainly based on the combination of expert systems and a BP neural network. The expert systems require the formulation of a large number of expert experience rules, while the BP network needs to use machine learning algorithms such as support vector machines to perform complex preprocessing and feature extraction on data in the early stage of network training. Factors such as expert rule formulation and feature extraction algorithms make the systems still artificially subjective to a certain degree, and some valuable data features may be discarded. Meanwhile, the more complex the expert rules and feature extraction algorithms, the higher the limitations of application conditions of a recognition system, and the poorer the adaptability and real-time performances. Therefore, it is difficult to meet the requirements of safety risk recognition while drilling, so there are few cases successfully applied to real-time recognition while drilling in drilling engineering.

### SUMMARY OF THE INVENTION

An objective of the present invention is to provide an intelligent recognition method for while-drilling safety risks based on a convolutional neural network, in order to overcome the defects of the prior art, expand sample data by using a small sample learning method, train and learn monitoring-while-drilling data by using a convolutional neural network having higher learning efficiency, implement autonomous learning feature extraction and feature learning, greatly simplify the data preprocessing process, reduce the subjectivity during network training, improve the applicability and real-time performance of a recognition system, and improve the recognition efficiency.

The object of the present invention is achieved through the following technical solution:

An intelligent recognition method for while-drilling safety risks based on a convolutional neural network, comprising the following steps:

1: processing while-drilling safety risk parameter features and data, and establishing a correlation analysis model for monitoring-while-drilling parameters by using a Pearson coefficient correlation analysis method;

2: processing while-drilling safety monitoring data, analyzing a time span of each sample, constructing training sample data and test sample data, and preprocessing the samples;

3: designing a while-drilling safety risk recognition network structure, and training a network model; and

4: recognizing the while-drilling safety risks by the trained safety risk recognition network.

Further, the step 1 specifically comprises the following sub-steps:

101: acquiring historical data of monitoring-while-drilling in multiple wells, initially screening out monitoring parameters that can reflect the changes in working conditions during the drilling process in a timely manner, and removing invalid or incorrect data;

102: further selecting a plurality of core parameters based on the importance of parameters in the monitoring-while-drilling process, to reduce the amount of subsequent data processing;

103: further classifying data sets in respective stages according to different stages of the drilling process; and

104: forming a macro law of changes in monitoring data corresponding to various safety risks by using an existing while-drilling safety risk theoretical model, and determining the composition of respective parameters in the most refined sample that characterizes various safety risk conditions in conjunction with Pearson parameter correlation analysis results.

Further, the step 2 specifically comprises the following sub-steps:

201: constructing a plurality of sample data with different time spans for each while-drilling safety risk, performing while-drilling safety risk recognition training by using a plurality of networks at the same time, and performing a comparative experiment to ensure that the networks can not only contain most of the features of the while-drilling safety risks, but also reduce the system delay as much as possible; and meanwhile, performing offline analysis on drilling monitoring data, and constructing the training sample data and the test sample data;

202: preprocessing sample data by using few sample learning, processing the samples by using scaling, cropping, interpolation and SMOTE algorithms in data enhancement, and transferring a weight in a trained similar network by using a transfer learning algorithm to a new network with a certain correlation for training; and

203: normalizing a part of data that has too big difference in numerical value in the samples.

Further, processing the samples by using scaling, cropping, interpolation and SMOTE algorithms in data enhancement is specifically as follows: for a part of historical data with a large increase amplitude and obvious change features, a part of the data in the changing process can be extracted and expanded to the same time span by using data scaling and cropping to form a new training sample, and then the scaled data is filled to make it the same as an original sample by using a piecewise interpolation method; and after the data scaling and interpolation, fewer samples are analyzed by using a SMOTE algorithm, and a new sample is artificially synthesized based on the fewer samples and added to a data set.

Further, the step 3 specifically comprises the following sub-steps:

301: selecting a network frame, and performing training and learning on downhole safety risks based on the convolutional neural network by using the while-drilling safety risk recognition network; performing feature extraction, i.e., pre-learning, on the sample data by using a convolutional layer, and then optimizing all network parameters by using a back-propagation algorithm; and

302: designing a network structure, which comprises an input layer, a convolutional layer 1, a convolutional layer 2, a hidden layer and an output layer; and performing a dimension reduction process on data before being inputted to a fully connected layer by using a principal component analysis method and by taking an elu function as an activation function.

Further, the convolutional layer 1 is used to extract the changing trend of each parameter, and a one-dimensional longitudinal convolution kernel of m*1 is used to perform separate convolution calculations on n parameters respectively.

Further, the convolutional layer 2 is used to extract a change relationship between parameters, and a one-dimensional transverse convolution kernel of 1*n is used to perform separate feature extraction on each row of a matrix.

Further, the principal component analysis method aims to reduce a set of N-dimensional vectors to K-dimensional vectors, where 0<K<N, and the calculation process includes the following steps:

3021: normalizing each row of a variable matrix of a p*n order to form a new matrix X according to columns;

3022: solving a covariance matrix of the m-order matrix X;

3023: calculating feature values and corresponding feature vectors of the covariance matrix C;

3024: arranging the feature vectors from top to bottom in rows according to magnitudes of the corresponding feature values to form a matrix, and then taking their corresponding k feature vectors as column vectors respectively to form a feature vector matrix P; and

3025: multiplying the matrix X and the matrix P to acquire data after reduction to k dimension.

Further, the number of nodes in the hidden layer is S=2x+1, where x is the number of nodes in the input layer; and the number of nodes in the hidden layer is S<N−1, where N is the number of network training samples.

The method of the present invention has the following beneficial effects: the autonomous-learning feature extraction of data is implemented by means of expansion of sample data with few sample learning, convolutional neural network learning and training of a network model, such that effective features of drilling monitoring data can be extracted efficiently, which can not only acquire a mutual restriction and association relationship of a plurality of monitoring-while-drilling parameters, but also extract change features of a plurality of monitoring parameters over a drilling process at the same time, and fully characterize the change law of monitoring data for while-drilling safety risks. The autonomous-learning feature extraction and feature learning are implemented, which greatly simplifies the data preprocessing process and reduces the subjectivity of network training. Compared with the existing recognition system, the trained model has low recognition delay, strong real-time performance, high accuracy, high application flexibility, and better generalization ability and anti-interference ability. Through the application test of while-drilling safety risk recognition of multiple wells in gas drilling, a plurality of safety risks such as formation gas production, formation water production and sticking can be successfully identified, which are consistent with the results of a monitoring-while-drilling report after drilling, thereby confirming the recognition effectiveness of the method. The method of the present invention satisfies the urgent needs for the reduction of current drilling cost and efficiency enhancement to a certain extent, and provides a new idea for the invention of an automatic recognition method for risks in intelligent drilling technologies in China.

### BRIEF DESCRIPTION OF THE DRAWINGS

FIG. 1 is a flowchart of a method of the present invention.

FIG. 2 is a graph of monitoring-while-drilling parameters in gas drilling.

FIG. 3 is a schematic diagram of small sample learning.

FIG. 4 is a schematic diagram of data preprocessing.

FIG. 5 is a comparison diagram of neural network structures.

FIGS. 6A and 6B are a structural diagram of a while-drilling safety risk recognition network.

FIG. 7 is a schematic diagram of training results of a formation gas production network.

FIG. 8 is a schematic diagram of training results of a formation water production network.

FIG. 9 is a schematic diagram of sticking training results.

FIG. 10 is a schematic diagram of training results of picking up stands.

### DETAILED DESCRIPTIONS OF THE PREFERRED EMBODIMENTS

It should be understood that the specific embodiments described here are only used to explain the present invention, but not used to limit the present invention.

The technical solutions in the embodiments of the present invention will be described clearly and completely in conjunction with the accompanying drawings in the embodiments of the present invention. Apparently, the described embodiments are merely some embodiments, rather than all embodiments, of the present invention. Based on the embodiments of the present disclosure, all other embodiments derived by a person of ordinary skill in the art without creative efforts shall fall within the protection scope of the present invention.

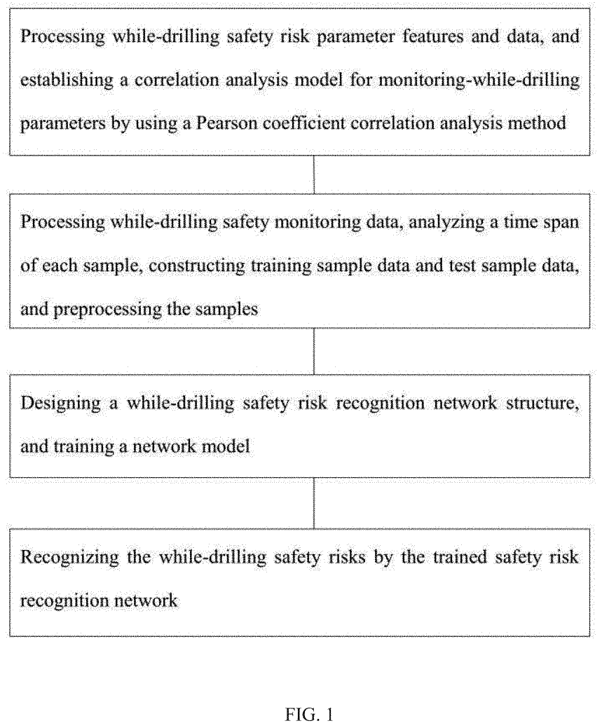

In this embodiment, as shown in FIG. 1, an intelligent recognition method for while-drilling safety risks based on a convolutional neural network comprises the following steps.

Step 1: processing while-drilling safety risk parameter features and data.

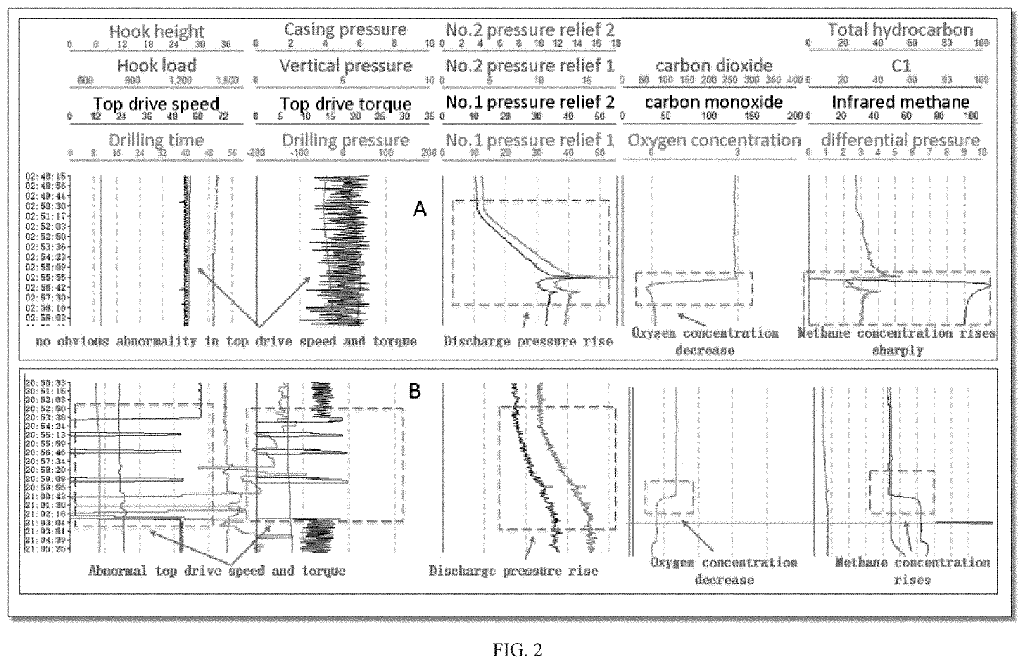

During the drilling process, there are often a large number of complicated monitoring instruments and monitoring data, such as logging data of hook load, top drive speed and riser pressure, monitoring data of gas components in main and auxiliary sand discharge, etc. As shown in FIG. 2, part of the monitoring data is displayed in real time in a form of a graph in a monitoring-while-drilling site according to actual needs, in order for monitoring personnel to observe and analyze the change trend of data in real time. The monitoring data is generally collected at a frequency of 1 to 5 seconds, and then stored in chronological order according to parameter types. The drilling monitoring data in a single day can reach more than 40,000 pieces.

The approximate working conditions of two wells in FIG. 2 are compared. FIG. 2 shows a schematic diagram of monitoring-while-drilling parameters of Well A, i.e., a well in Dayi, which encounters formation gas production during drilling, in which a methane concentration and a discharge pressure have risen sharply, while there is no obvious abnormality in top drive speed and top drive torque. FIG. 2 shows a schematic diagram of monitoring-while-drilling parameters of Well B, i.e., a new well, which encounters formation gas production during drilling, in which a methane concentration and a discharge pressure have risen slightly, while a top drive speed and a top drive torque are abnormal due to induced sticking. It can thus be seen that the while-drilling safety risks during drilling are highly complex, different risks have different parameter feature, and the same kind of safety risks also have different features in different wells affected by geological conditions, manual operations and other factors. Therefore, it is difficult for the on-site personnel who do not have the professional knowledge level and rich experience to accurately judge downhole drilling conditions through monitoring-while-drilling parameters. On the other hand, since monitoring-while-drilling parameters is large in data volume and high in refresh frequency, if the time spent by a monitoring system to process data is too long, real-time monitoring will be meaningless. Therefore, an intelligent while-drilling safety risk recognition method with high recognition accuracy and strong real-time performance is of great significance to drilling engineering.

Taking gas drilling as an example, its important while-drilling safety risks mainly include the following aspects: formation gas production, formation water production, sticking, drilling tool fracture, downhole explosion, hydrogen sulfide production, borehole instability, etc. When a wide variety of monitoring-while-drilling parameters are all used for while-drilling safety risk analysis, high model complexity and large difficulty in network training will be caused. Therefore, a corresponding relationship between the while-drilling safety risks and the monitoring-while-drilling parameters needs to be macro-controlled. According to the method of the present invention, a correlation analysis model is established for the monitoring-while-drilling parameters by using a Pearson coefficient correlation analysis method. The main steps are as follows.

(1) Historical data of monitoring while drilling in each well is sorted; monitoring data in the drilling process is screened out and invalid or incorrect data caused by acquisition instruments, signal transmission and the like is removed, in order to judge the correlation of various parameters more accurately.

(2) Parameters are further screened according to the importance of the parameters in the monitoring-while-drilling process. As shown in Table 1, in this embodiment, a total of 13 core monitoring parameters are finally selected for Pearson correlation coefficient analysis.

TABLE 1
13 Parameters for Pearson correlation coefficient analysis

| Data | Parameter | Data | Parameter |
|---|---|---|---|
| source | type | source | type |
| Conven- | Hook height | Components | Hydrogen sulfide concentration |
| tional | Hook load | of return | Oxygen concentration |
| drilling | Top drive | gases from | Carbon monoxide concentration |
| parameters | speed | sand | Carbon dioxide concentration |
| | Top drive | discharge | Methane concentration |
| | torque | pipeline | Return gas humidity |
| | Riser | | Return gas temperature |
| | pressure | | Pipeline discharge pressure |

(3) The methane concentration in the parameters is meaningful in the historical monitoring data of each well only after gas is produced in the formation, and data before gas production is all zero. If all the sorted data are directly analyzed, correlation coefficients between the methane concentration parameter and other parameters will be affected greatly. Therefore, when data sets of the current stage are further classified and correlation coefficients of non-methane concentrations are calculated, methane concentration parameter data in the current stage data is deleted and regarded as a data set A; and when the correlation coefficients between the methane concentration and other parameters are calculated, all data with a methane concentration value of 0 in the current stage are deleted and regarded as a data set B. The distribution of the data sets is shown in Table 2.

TABLE 2
Volumes of grouped data sets

| | | Data |
|---|---|---|
| Data set | Description | volume |
| Data set A | Not including methane concentration parameter | 115,842 |
| Data set B | Not including data with a methane concentration | 77,898 |
| | value of 0 | |

(4) Pearson correlation coefficient analysis results are calculated based on the data set A and the data set B, and can be displayed in a form of a thermodynamic diagram.

The change law of various safety risk data in the historical data are sorted out based on the correlation analysis results and in conjunction with the existing while-drilling safety risk theoretical model and the experience of multiple experts. The change features of some important safety risk parameters are shown in Table 3.

TABLE 3
Features of important safety risk parameters of gas drilling

| | Formation | Formation | | Drill | | Hydrogen | | Picking |
|---|---|---|---|---|---|---|---|---|
| | gas | water | | tool | Downhole | sulfite | Borehole | up |
| Parameter type | production | production | sticking | fracture | explosion | production | instability | stands |
| Hook height | | | | | | | | • |
| Hook load | | • | | • | | | • | • |
| Top drive speed | | | • | | | | • | • |
| Top drive torque | | | • | • | | | • | • |
| Riser pressure | • | | • | • | • | | | • |
| Hydrogen sulfite | | | | | | • | | |
| Oxygen concentration | • | | | | • | | | |
| Carbon monoxide | | | | | | | | |
| concentration | | | | | | | | |
| Carbon dioxide | | | | | • | | | |
| concentration | | | | | | | | |
| Methane | • | | | | • | | | |
| concentration | | | | | | | | |
| Return gas humidity | | • | | | | | | |
| Return gas | | • | | | • | | | |
| temperature | | | | | | | | |
| Pipeline discharge | • | | • | • | • | | | • |
| pressure | | | | | | | | |

It should be noted that in the analysis results, picking up stands is a normal work flow in the drilling process. As the drilling process continues to deepen, the length of the existing drill string will not be able to meet length requirements for further drilling, so new drill strings will be continuously picked up during the entire drilling process. However, due to a series of operations such as annular gas pressure relief and frequent rise and fall of a drilling tool during the process of picking up stands, abnormal changes in various monitoring parameters, such as the surge of the discharge pressure in a sand discharge pipeline, a hook load, and a hook height, a torque and frequent rise and fall of riser pressure, will be caused. In addition, due to the accumulation of gas in the well, the humidity of return gas will increase rapidly at the end of picking up stands. After drilling into a gas layer, the methane concentration and total hydrocarbons in the return gas components will increase. Therefore, in the case that the while-drilling safety risk recognition method is invented, it is likely to cause misjudgments for various safety risks in the process of picking up stands if the recognition to the process of picking up stands is added. On the other hand, Table 2 is intended to grasp the macroscopic change law of monitoring-while-drilling parameters. However, quantitative analysis is hardly implemented since different wells have different change amplitudes and ratios. In addition, a further analysis is also needed because of the shortage in generalization capabilities for the recognition for multiple wells with large differences in geological conditions.

Step 2: while-drilling safety monitoring data is processed. As described above, the monitoring-while-drilling parameters are mostly collected in chronological order and stored in a two-dimensional array composed of multiple parameters. Most of the while-drilling safety risks can be effectively identified based on the change trend of parameters in the two-dimensional array and the change relationship between the parameters. Therefore, a sample structure of a while-drilling safety risk recognition network should be a two-dimensional array composed of monitoring data of multiple safety risk parameters over a period of time.

(1) Time spans of samples are analyzed. When historical data is converted into neural network input data, a time span of a single sample needs to be considered. As shown in FIG. 2, time spans of changes in different parameters are different when the same type of while-drilling safety risks occurs, and accordingly, time spans of changes in the same type of parameters are also different when different types of while-drilling safety risks occur. The time spans of changes in respective parameters under different while-drilling safety risks vary greatly. The shortest time span, such as the top drive speed and top drive torque during sticking, is only for an instant. The humidity of the return gas from the sand discharge pipeline having a long change time span, for example, during water production in the formation, will continue to rise for several hours. Therefore, when neural network training samples are constructed, if the time span selected for a single sample is too short, the features of the single sample will be incomplete, and unable to cover all the changing features of parameters, which will reduce the efficiency of network learning. If the selected time span is too long, parameter features of the network during training will be complex. If the learning efficiency of the network for effective features is low, the recognition system subjected to network training will be caused to have a high time delay for the recognition of some while-drilling safety risks such as sticking and formation gas production during the application, thereby missing the optimal early warning time and losing the application value of the recognition system.

In view of such problems, according to the method of the present invention, sample data with three different time spans are established for each while-drilling safety risk, and while-drilling safety risk recognition training is performed by using three networks at the same time. A comparative experiment is made to ensure that the networks can not only contain most of the features of the while-drilling safety risks, but also reduce the system delay as much as possible. The distribution of time spans of the four types of recognition network samples is shown in Table 4. On the other hand, each sample takes 2 seconds as a time interval between data within the sample, which can not only contain complete features of most of the while-drilling safety risks, but also reduce the complexity of the model and the difficulty of network training as much as possible.

TABLE 4
Distribution of time spans of samples

| | Sample | Sample | Sample |
|---|---|---|---|
| | Time span 1 | Time span 2 | Time span 3 |
| Formation gas production | 20 s | 40 s | 60 s |
| Formation water production | 20 s | 40 s | 60 s |
| Sticking | 20 s | 40 s | 60 s |
| Picking up stands | 120 s | 150 s | 180 s |

Subsequently, based on Table 3, offline analysis is performed on the drilling monitoring data to preliminarily construct training sample data and test sample data. Taking a 40-second sample of formation gas production as an example, Table 5 shows a schematic diagram of a single sample after extraction. The single sample is 20*5 two-dimensional data.

TABLE 5
Schematic diagram of a single sample

| Sample of formation gas production | | | | | Sample or normal drilling | | | | |
|---|---|---|---|---|---|---|---|---|---|
| Discharge | Discharge | Riser | Methane | Oxygen | Discharge | Discharge | Riser | Methane | Oxygen |
| pressure A | pressure B | pressure | concentration | concentration | pressure A | pressure B | pressure | concentration | concentration |
| 35.98 | 30.5 | 2.08 | 75.63 | 1.27 | 12.43 | 10.48 | 2.44 | 0 | 3.29 |
| 36.23 | 30.55 | 2.32 | 84.3 | 0.93 | 12.48 | 10.55 | 2.45 | 0 | 3.29 |
| 35.25 | 30 | 2.21 | 85.1 | 0.66 | 12.35 | 10.3 | 2.44 | 0 | 3.29 |
| 35.4 | 29.63 | 2.21 | 86.75 | 0.59 | 12.35 | 10.38 | 2.44 | 0 | 3.29 |
| 36.2 | 30.58 | 2.53 | 93.52 | 0.39 | 12.28 | 10.18 | 2.44 | 0 | 3.29 |
| 35.98 | 30.65 | 2.31 | 97.08 | 0.28 | 12.35 | 10.45 | 2.45 | 0 | 3.28 |
| 35.65 | 30.25 | 2.39 | 97.29 | 0.16 | 12.28 | 10.33 | 2.44 | 0 | 3.28 |
| 35.78 | 30.25 | 2.39 | 97.97 | 0.06 | 12.28 | 10.38 | 2.44 | 0 | 3.28 |
| 36.2 | 31 | 2.38 | 98.22 | 0.05 | 12.28 | 10.25 | 2.45 | 0 | 3.28 |
| 36 | 30.35 | 2.45 | 98.3 | 0.05 | 12.35 | 10.4 | 2.45 | 0 | 3.28 |
| 36.2 | 30.65 | 2.48 | 99.41 | 0.042 | 12.23 | 10.25 | 2.44 | 0 | 3.28 |
| 35.33 | 29.98 | 2.52 | 99.41 | 0.035 | 12.28 | 10.53 | 2.45 | 0 | 3.28 |
| 35.48 | 30 | 2.13 | 99.15 | 0.033 | 12.35 | 10.4 | 2.44 | 0 | 3.28 |
| 35.7 | 30.28 | 2.43 | 99.07 | 0.03 | 12.28 | 10.33 | 2.44 | 0 | 3.28 |
| 36.8 | 31.23 | 2.48 | 97.55 | 0.03 | 12.33 | 10.3 | 2.44 | 0 | 3.29 |
| 37.5 | 31 | 2.74 | 96.45 | 0.02 | 12.48 | 10.48 | 2.44 | 0 | 3.29 |
| 37.03 | 31.43 | 2.71 | 96 | 0.025 | 12.28 | 10.33 | 2.44 | 0 | 3.29 |
| 37.88 | 31.93 | 3.09 | 95 | 0.021 | 12.4 | 10.33 | 2.44 | 0 | 3.29 |
| 37.1 | 31.63 | 2.64 | 94.24 | 0.12 | 12.28 | 10.33 | 2.44 | 0 | 3.29 |
| 37.53 | 31.7 | 2.83 | 93.39 | 0.11 | 12.28 | 10.38 | 2.44 | 0 | 3.29 |

The number of a part of constructed samples is shown in Table 6. The data in the second and third columns in the table is only the number of samples with safety risk features. Although the volume of monitoring-while-drilling data can reach more than 40,000 pieces in a single day, there are few effective data that can characterize the occurrence of while-drilling safety risks, and the data volume of the constructed safety risk samples is very limited. In order to avoid sample imbalance, a ratio of samples of different types in the sample set generally does not exceed 1:2. Therefore, the total number of the complete sample sets in the present invention is shown in the fourth and fifth columns of the table. The overall number of test sample sets is relatively large because of being not subject to this restriction.

TABLE 6
Overview of the number of some while-drilling safety risk samples

| | Number of | Number of | | |
|---|---|---|---|---|
| | samples in | samples in | Number of | Number of |
| | training sets | test sets | samples in | samples in |
| Types of | of safety | of safety | complete | complete |
| safety risk | risk type | risk type | training sets | test sets |
| Formation gas | 32 | 10 | 80 | 103 |
| production | | | | |
| Formation water | 18 | 10 | 50 | 55 |
| production | | | | |
| Sticking | 22 | 10 | 50 | 53 |
| Picking up stands | 26 | 10 | 70 | 72 |

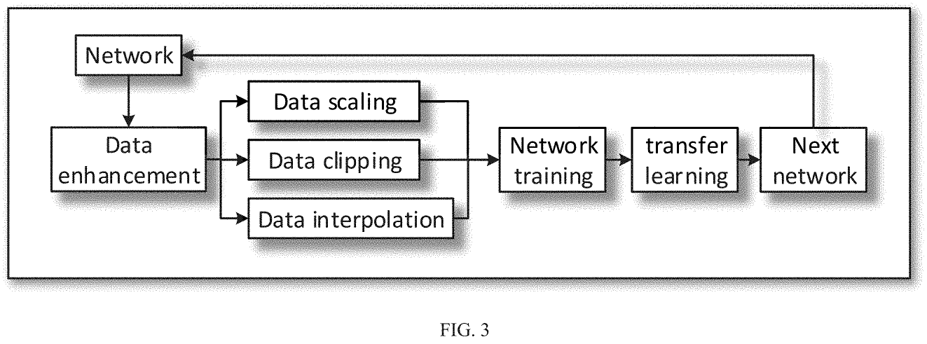

(2) Effective features of data are hardly extracted efficiently by a network because of the small number of safety risk samples in the sample set. Therefore, the sample data is preprocessed by using few sample learning. As shown in FIG. 3, in the case of few samples, data enhancement and transfer learning algorithms are mainly adopted in the present invention. Scaling, cropping, interpolation and SMOTE algorithms in data enhancement are used to process the samples. Data scaling, cropping, and interpolation algorithms enrich the number of samples while retaining the features of the samples. The SMOTE algorithm expands the number of samples while reducing the imbalance of the samples, such that the categories in original samples are no longer seriously unbalanced. The data enhancement algorithm improves the efficiency of network learning from the root cause and reduces the probability of network overfitting. The transfer learning algorithm aims to transfer the weights in the trained similar network to a new network with certain relevance for training, such that the new network no longer learns from the very beginning, thereby improving the learning efficiency from the network level. The transfer learning algorithm can well assist in network learning in a network in the shortage of samples, thereby improving the recognition accuracy of the network.

In parameter features of while-drilling safety risks, the change mode of each parameter, that is, the increase or decrease, and the overall change law of all parameters, are more important than the change amplitude of each parameter. Therefore, for some historical data with large rises and obvious change features, data scaling can be used to extract and expand part of the data during the change process to the same time span to form a new training sample. Subsequently, a piecewise interpolation method is used to fill in the scaled data to make it the same as the original sample. The piecewise interpolation method makes use of Latencyrangian piecewise interpolation, and its formula is as follows:

$${L}_{n} ( x ) = {\sum }_{i = 0}^{n} ( {y}_{i} * {\prod }_{j = 0 , j \neq i}^{n} \frac{x - {x}_{j}}{{x}_{i} - {x}_{j}} )$$

The SMOTE algorithm is used after data scaling and interpolation. Fewer samples are analyzed through the SMOTE algorithm, and a new sample is artificially synthesized based on the fewer samples and added to a data set, thereby further improving the recognition performance of the network. The synthesis formula of the SMOTE algorithm is as follows:

(x_{new}, y_{new})=(x, y)+rand(0−1)*((xₙ−x), (yₙ−y))

in which, (x_{new}, y_{new}) is a new sample point, (x, y) is an original sample point, and (xₙ−yₙ) is the nearest neighbor of the original sample point.

After the data enhancement process, the distribution of part of the training set samples and test set samples of while-drilling safety risks is shown in Table 7. Compared with Table 6, the number of various samples has increased significantly.

TABLE 7
Overview of the number of some while-drilling safety risk samples

| | Number of | Number of | | |
|---|---|---|---|---|
| | samples in | samples in | Number of | Number of |
| | training sets | test sets | samples in | samples in |
| Types of | of safety | of safety | complete | complete |
| safety risk | risk type | risk type | training sets | test sets |
| Formation gas | 86 | 30 | 240 | 99 |
| production | | | | |
| Formation water | 83 | 30 | 180 | 99 |
| production | | | | |
| Sticking | 79 | 30 | 200 | 99 |
| Picking up stands | 84 | 30 | 160 | 83 |

The transfer learning algorithm needs to preferentially train a kind of risk types with abundant samples and obvious sample features, such as formation gas production, when performing network training. Then, the trained network weights are transferred to the training of a kind of risk types with few samples and unobvious sample features, such as formation water production, and the learning efficiency of the latter network is enhanced. In the transfer process, if the feature extraction is very difficult for image recognition of monitoring-while-drilling parameter curves and logging curves, the hidden layer or output layer should generally be locked, and the convolutional layer, i.e., feature extraction layer should be trained emphatically. For general two-dimensional parameter analysis, if the consistency of features between different scenes is relatively high, but the numerical value ranges are different, the convolutional layer should be locked, and the hidden layer or output layer behind the convolutional layer should be fine-tuned or partially fine-tuned. In this way, the network is maintained to be stable basically, the existing training results can be consolidated, and the follow-up training efficiency can be improved.

(3) On the other hand, some parameters need to be normalized because the network training effect is affected due to the large difference in the numerical values in the samples. Among the extracted parameters, the numerical values of parameters such as methane concentration, oxygen concentration and relative humidity range 0 to100 (percentage) respectively, so the remaining parameters are normalized to the maximum and minimum by using the above parameters as standards according to the following formula:

$${x}^{*} = \frac{x - {x}_{min}}{{x}_{max} - {x}_{min}} \times 100.$$

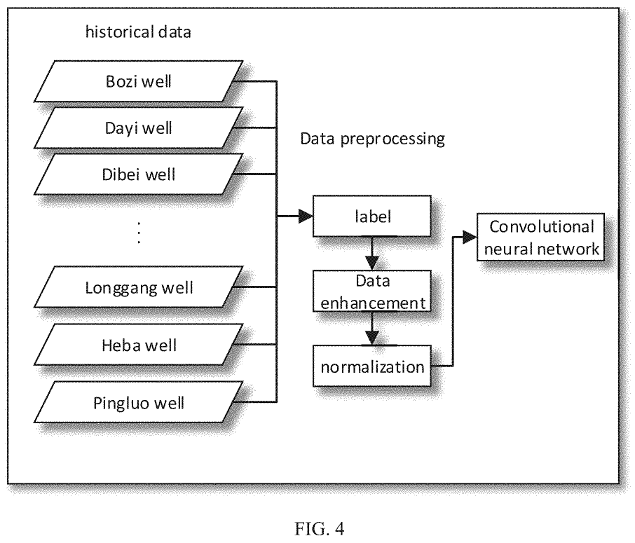

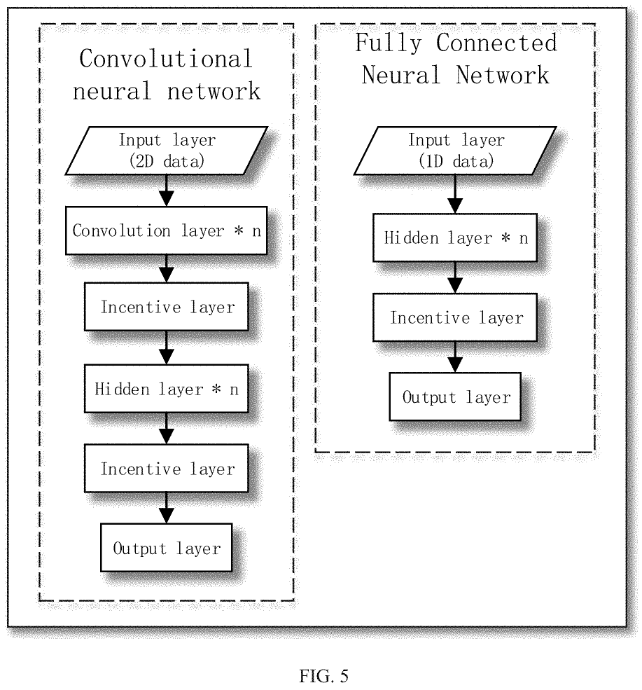

In the early stage of training of the present invention, the complete data sample construction method is shown in FIG. 4. The historical monitoring parameters totally involve more than ten wells in multiple blocks, such as Bozi Well and Dibei Well in Xinjiang, Dayi Well, Laojun Well and Longgang Well in Sichuan, etc. The more than ten wells have large spans and rich sample features, and the commonality and difference performance among different wells further improve the generalization ability of the model.

Step 3: designing a while-drilling safety risk recognition network structure, and training a network model.

(1) A fully connected neural network is compared with a convolutional neural network according to the features of drilling parameters. The fully connected neural network is used to train and learn data by simply using a hidden layer and a backward-propagation algorithm, and the input layer only supports one-dimensional data. However, as described above, data samples of monitoring-while-drilling can be regarded as two-dimensional data. If a fully connected neural network is used, all positional relationships between data will be discarded. The input layer of the convolutional neural network supports two-dimensional data and retains all the features of the while-drilling safety risk samples. Based on the hidden layer, the convolutional layer is preferentially used to perform feature extraction, i.e., pre-learning, on the sample data, and optimize all network parameters by using the backward-propagation algorithm. The optimization on parameters of the convolutional layer made by the backward-propagation algorithm based on the gradient descent of a loss function realizes the autonomous-learning feature extraction. That is, in the process of training and learning, the network constantly improves the feature extraction algorithm of the convolutional layer according to the quality of the training results, which not only improves the extraction rate of effective features of the samples, but also greatly reduces the artificial subjectivity of the entire system.

In summary, according to the method of the present invention, the convolutional neural network is selected to carry out the training and learning of the downhole safety risks, such that the effective features of the monitoring parameters can be extracted more efficiently, thereby improving the network training efficiency. The trained recognition system also has higher accuracy and real-time performance.

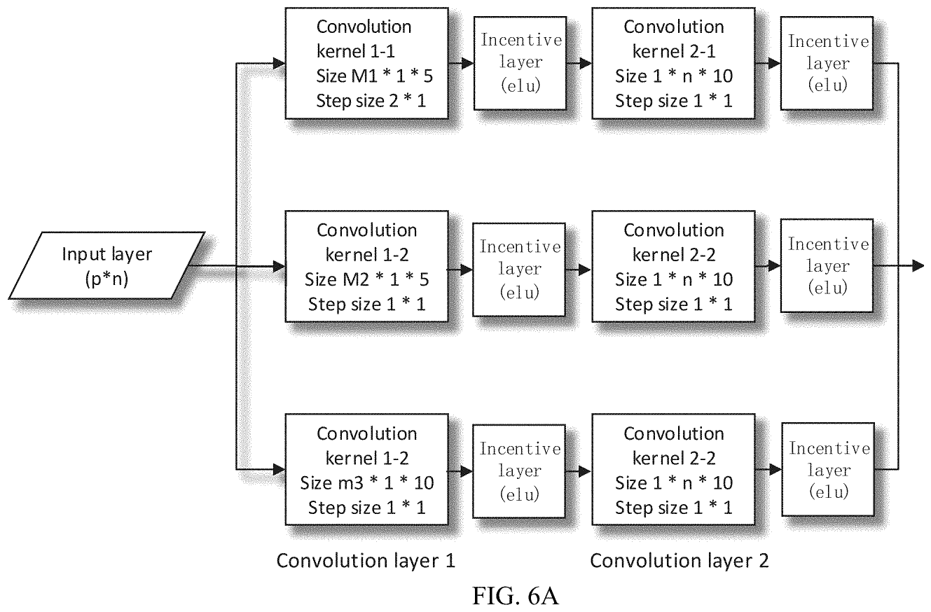

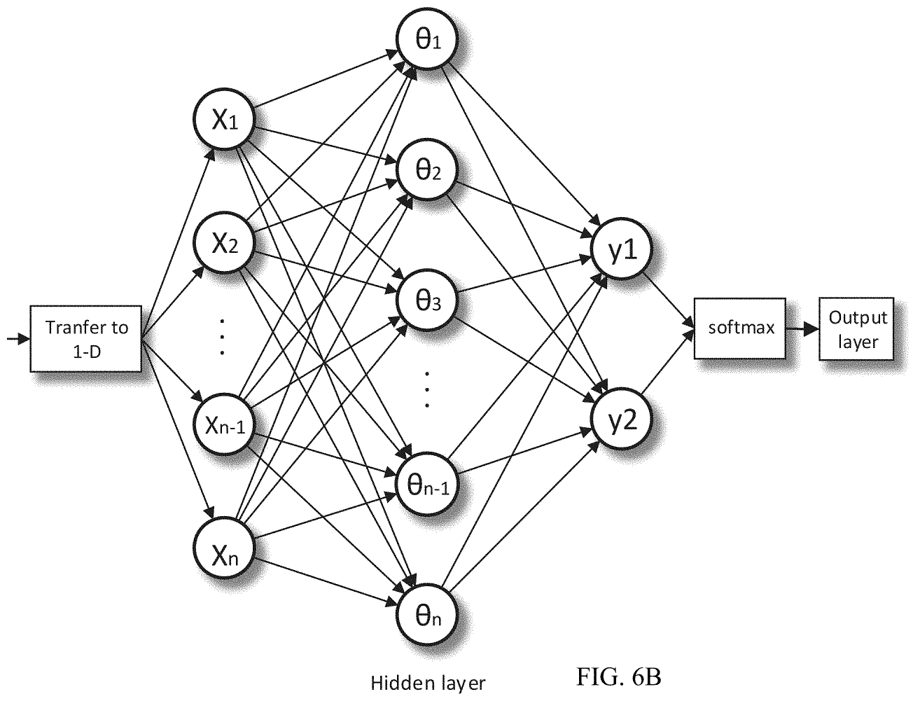

(2) The present invention is based on the basic structure of the convolutional neural network shown in FIG. 3. In conjunction with the features of the while-drilling safety risk samples, the constructed while-drilling safety risk recognition network structure is shown in FIGS. 6A and 6B.

Input layer: as mentioned above, in order to improve the recognition accuracy, a single sample of the present invention selects 1 minute as the time span. At the same time, in order to reduce system calculations and improve the network recognition efficiency and real-time performance, a single sample selects a data collection frequency of 2 seconds. Data of the final input layer forms a 30*n two-dimensional matrix, where n is the number of various safety risk feature parameters.

Convolutional layer: through the convolution operation of a plurality of convolutional layers and a plurality of convolution kernels, multiple features of the input layer can be extracted to improve the network learning efficiency and the generalization ability. As shown in Table 1, the features of most safety risks are mainly reflected in two aspects: the change trend of each parameter itself and the corresponding change relationship between different parameters. Therefore, in order to well extract the effective features of a plurality of monitoring-while-drilling parameters, in the convolutional neural network model of the present invention, two convolutional layers are used for feature extraction, focusing on the two aspects of risk parameter features respectively. The convolutional layer 1 is responsible for extracting the changing trend of each parameter itself. Since the input layer is a two-dimensional array of p*n, and each column in the array reflects a numerical value change of a single parameter over time, the convolutional layer 1 performs separate convolution calculations on n parameters respectively by using a one-dimensional longitudinal convolution kernel of m*1. Meanwhile, because the parameter features of different risks have different time spans, for example, formation water production is often reflected in the entire data change of 1 minute, sticking occurs in an instant. In order to be more compatible with most while-drilling safety risk features, the convolutional layer 1 contains 3 types of m*1 convolution kernels, a total of 20 convolution kernels being used, and each parameter is individually subjected to feature extraction at different lengths. In the three networks with different time spans, the values of m and s are shown in Table 8. The weight of each convolution kernel in convolution kernels of the same size is different. An input matrix is subjected to feature extraction more comprehensively by using a plurality of convolution kernels having the same size and different weights, but the number of the convolution kernels should not be too large, otherwise it is likely to cause the failure of the network to converge correctly.

TABLE 8
Values of parameters m and s in convolutional layer 1

| | 20 s/120 s | 40 s/150 s | 60 s/180 s |
|---|---|---|---|
| Convolution kernel | network | network | network |
| Convention kernel 1_1 having a | 5/20 | 5/25 | 10/30 |
| size of m1 | | | |
| Convention kernel 1_2 having a | 10/40 | 15/50 | 20/60 |
| size of m2 | | | |
| Convention kernel 1_3 having a | No convention | 20/75 | 30/90 |
| size of m3 | kernel/60 | | |
| Convention kernel 1_1 having a | 1/4 | 2/4 | 2/6 |
| step length of s1 | | | |
| Convention kernel 1_2 having a | 1/2 | 1/2 | 1/3 |
| step length of s2 | | | |
| Convention kernel 1_3 having a | No convention | 1/2 | 1/3 |
| step length of s3 | kernel/2 | | |

The convolutional layer 2 is responsible for extracting a change relationship between parameters, and a one-dimensional transverse convolution kernel of 1*n is used to perform separate feature extraction on each row of a matrix. Although it is a one-dimensional convolution kernel, what the one-dimensional convolution kernel of the convolutional layer 2 finally extracts is the change relationship between a plurality of risk parameters under different time spans since each element in the matrix processed by the convolutional layer 1 has a different length, that is, the change feature of a single parameter under different time spans. The convolutional layer 2 uses a total of 20 convolution kernels. The combination of the convolutional layer 1 and the convolutional layer 2 realizes a feature extraction algorithm for the two-dimensional matrix, which cannot be accomplished by a BP neural network.

Activation function: in order to enhance the nonlinear processing ability of the network and improve the learning efficiency, the network uses an elu function as the activation function:

$$f ( x ) = \{ \begin{matrix}x & , x > 0 \\ α ( {e}^{x} - 1 ) & , x \leq 0\end{matrix} .$$

Among the commonly used activation functions, a Relu function has the advantages of simple derivative calculation, fast gradient descent and quick model convergence speed, and is suitable for most networks. However, the Relu function may cause neuron necrosis when a learning rate is too large or there is a problem in parameter initialization. That is, some neurons will never be activated and the corresponding parameters will never be updated. The elu function is an improved version of the Relu function. When the input is negative, the elu function has a certain output value, which alleviates the phenomenon of neuron necrosis. a, as an adjustable parameter, poses a certain anti-interference ability to the function. After the network training comparison test, the elu function has a faster convergence rate than the Relu function. In the network training of formation water production, the accuracy rate is increased by 13%.

Principal component analysis method: in the network structure of this embodiment, each sample has passed through multiple sets of convolutional layers. Each convolutional layer also extracts the features of samples from a plurality of angles by using a plurality of convolution kernels of different sizes. The extracted data inevitably contains redundant information and noise information, and the plurality of convolution kernels and convolution layers may also cause convoluted data to contain repetitive features. For a network with a sufficient number of samples, effective features of input information are further screened out by the network from the fully connected layer of the rear section by means of a large number of sample training. However, for such a network with insufficient amount of samples in this embodiment, the effective information of each sample cannot be learned efficiently, which affects the training efficiency of the network and the recognition accuracy of the recognition system. Therefore, in the case of network training in this embodiment, prior to inputting the data into the fully connected layer, it is necessary to perform the dimension reduction on the data by using the principal component analysis method, thereby reducing invalid information and repeated features in the data, and improving the learning ability of the model to effective features from the perspective of the network structure. The principal component analysis method aims to reduce a set of N-dimensional vectors to K-dimensional vectors, where K is greater than 0 and less than N. The main calculation process is as follows:

A) normalizing each row of a variable matrix of order p*n to form a new matrix X according to columns;

B) solving a covariance matrix of the m-order matrix X;

C) calculating feature values and corresponding feature vectors of the covariance matrix C;

D) arranging the feature vectors from top to bottom in rows according to magnitudes of the corresponding feature values to form a matrix, and then taking their corresponding k feature vectors as column vectors respectively to form a feature vector matrix P; and

E) acquiring Y=XP, i.e., the data after reduction to k dimension.

Since three convolution kernels are used in each of most of the network convolutional layers in this embodiment, convoluted data has the repetitive features by at least three times, so data dimension reduction needs to reduce the dimension of the convoluted data to one-third of the original dimension.

Fully connected layer: after data dimension reduction, a conventional fully connected neural network is used. Due to the small number of samples and low model complexity, a hidden layer is used. Based on Kolmogorov's theorem, the number of nodes in the hidden layer should satisfy the following formula: S=2x+1; where S is the number of nodes in the hidden layer and x is the number of nodes in the input layer. In addition, the number of nodes in the hidden layer must be less than N−1, where N is the number of network training samples, otherwise the system error of the network model is not related to the features of the training samples and tends to zero. That is, the established network model has neither generalization ability nor practical value. Therefore, the hidden layer of this network contains 150 nodes. The used activation function used is also the elu function.

The output layer of the network is in a binary form, having two nodes. The output layer uses a Softmax function:

$${S}_{i} = \frac{{e}^{{y}_{i}}}{{\sum }_{i}^{C} {e}^{{y}_{i}}}$$

in which, yᵢ is an input value of the Softmax function, and C is the number of input values.

The Softmax function can convert multiple types of output values of the network into relative probability. That is, through the Softmax function, the output of the network is converted into a value between 0 and 1, having a sum of 1. Softmax makes the final output of the recognition system as the relative probability of the occurrence of a safety risk, and the recognition result is more intuitive and efficient. A cross-entropy loss function is accordingly selected as a network loss function.

Step 4, recognizing while-drilling safety risks by the trained safety risk recognition network.

Training results and analysis of some safety risks: this section has completed the construction and training of the entire network. Some safety risk training results are described below. The abscissa in the figure shown in this section is the number of training, and the ordinate is a loss value or sample accuracy (%).

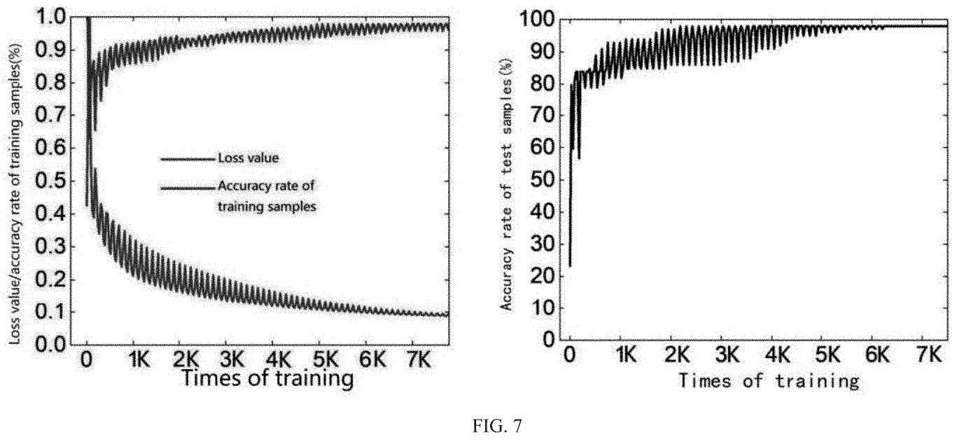

(1) Formation gas production: among the network training effects of formation gas production from three different time spans, the amount of data in a single sample of a 20 s network is small, such that training is easily implemented and loss value decreases more rapidly. However, since the sample contains fewer valid data features, the loss value is difficult to decrease after about 6000 times of training. The accuracy on the entire training set samples does not increase anymore after reaching 90%. The accuracy on the test set samples is only 80% or so. The accuracy of the test set samples is quite different from the accuracy of the training set samples, such that the network has a certain degree of overfitting. However, a 40 s network and a 60 s network have a large amount of data in a single sample, such that the samples contain rich data features, and the final training effect is better. The final loss value of the 60 s network is less than 0.1, and the accuracy of the training set and the accuracy of the test set are both higher than 95%. The results of the 60 s network training are shown in FIG. 7.

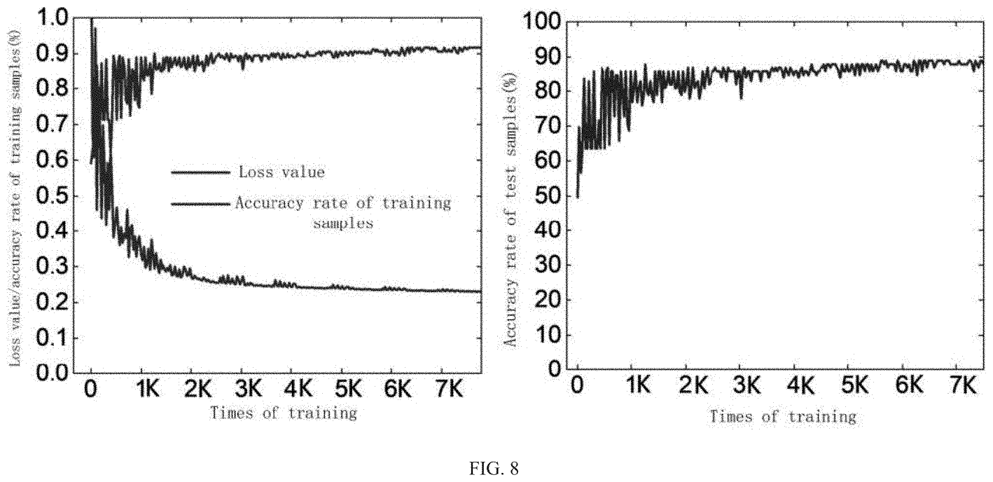

(2) Formation gas production: among the training effects of formation water production networks, the loss value and accuracy of the model tend to be stabilized after about 5000 times of training of the three formation water production networks. Like formation gas production networks, as the time span of a single sample increases, the data features contained in the sample become more abundant, the network training effect is better, and the final recognition accuracy rate is optimal in the 60 s network. The change trend in the accuracy rate of the training set is basically synchronized with that of the test set, and the final accuracy rate of the training set is also very close to that of the test set, thereby basically eliminating the possibility of overfitting. The results of the 60 s network training are shown in FIG. 8.

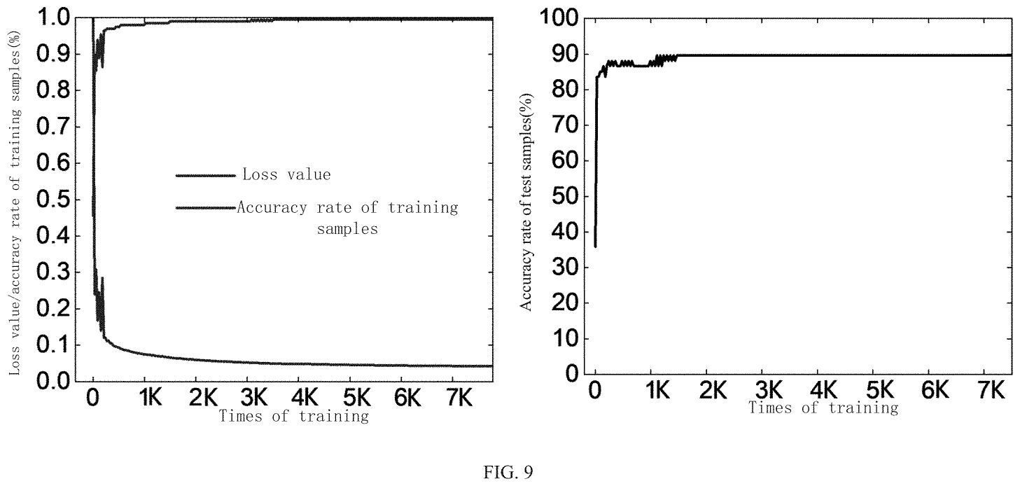

(3) Sticking: in a sticking network, after only about 1000 times of trainings for the 40 s network and the 60 s network, the network loss value is less than 0.1, the accuracy of each training set is higher than 95%, and the accuracy of each test set is higher than 90% and tends to be stable. Due to the obvious features of the sticking risk, it is beneficial for the network to learn effective features faster. During the training process, the network converges quickly, the loss value drops quickly, and the accuracy rates of the final training sets are basically the same. The 60 s network is shown in FIG. 9.

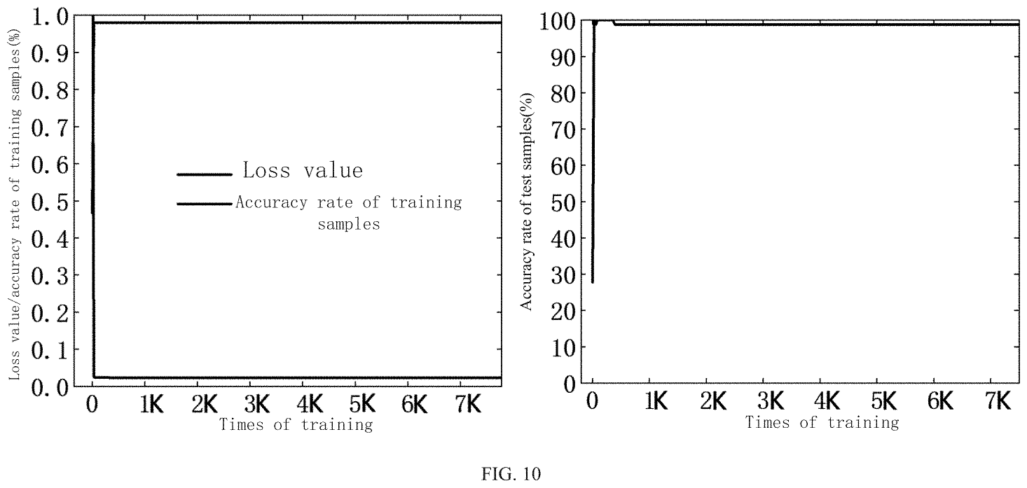

(4) Picking up stands: because changes in five parameters of a picking-up stand network are all cliff-like changes and the features are very obvious, the loss values of three network training processes of picking up stands converge extremely fast, the accuracy rate of the training set and the accuracy rate of the test set rise rapidly, and the training effect is very good. Final training results of a 180 s picking-up stand network training are shown in FIG. 10.

In summary, the optimal test set accuracies of the four recognition networks after training are 98%, 87.9%, 98%, and 98.7% respectively. It can thus be seen that, in three safety risks and the training process of picking up stands, the model has reached a considerable recognition accuracy rate. It is indicated that the model has good recognition efficiency in drilling safety risk recognition. If the number of samples can be increased, the generalization ability of the model can be further improved.

Practical on-site application: after all the trained models are integrated, on-site real-time warning application tests for while-drilling safety risks are carried out for several times, such as for while-drilling safety risks in Dayi* well and Deyang Xin* well in the Dayi block. In conventional monitoring while drilling, because there is no intelligent monitoring and alarm system on site, logging and related parameter monitoring personnel generally do monitoring work in shifts around the clock. If abnormal parameters are found, they shall be reported to 24-hour shift decision-making personnel in a well team to comprehensively judge working conditions, and then notify a driller to take the next construction measures. Monitoring and judgment are labor intensive, poor in timeliness, high in misjudgment rate, poor in reliability, and difficult to deal with emergencies in time, and have high requirements on the theoretical knowledge and monitoring experience of on-site monitoring personnel. In several on-site real-time early warning application tests of the present invention, most of the safety risks in the drilling process are successfully recognized and warned, which greatly reduces the labor intensity of on-site monitoring personnel. In the real-time recognition process of the drilling site, this system can recognize downhole safety risks before the on-site monitoring personnel, with low recognition delay, strong timeliness and high recognition accuracy.

Take Dayi* well as an example, in the real-time warning application test of while-drilling safety risks in this well, the recognition system successfully recognizes formation gas production, formation water production, sticking risk, and stand picking-up work for several times. When a measured well depth of 5149.18 m is reached in the on-site drilling engineering, the recognition system makes a warning in the first time that the formation gas production probability reaches 97.25%. Upon the reception of the warning from the recognition system, the on-site monitoring personnel further confirm that a small amount of methane gas is encountered, and the recognition system will success in warning. When a measured well depth of 5173.06 m is reached in the on-site drilling engineering, the recognition system makes a remind that the stand picking-up work has started on the site, and stops the recognition for formation gas production, formation water production, and sticking risks, and the recognition results are consistent with the on-site drilling workflow. When a measured well depth of 5254.58 m is reached in the on-site drilling engineering, the recognition system promptly reminds that the probability of formation water production is as high as 83.54%. After being reminded by the system, the on-site monitoring personnel will report to the decision-maker and confirm that a water layer has been drilled according to a sand discharge condition, and the recognition system will succeed in warning. When a measured well depth of 5254.69 m is reached in the on-site drilling engineering, the recognition system reminds that the sticking probability is as high as 96.54%, and then, the on-site monitoring personnel judge that a drilling tool is stuck and notify the driller to deal with the sticking phenomenon.

The above content is some real-time early warning test conditions of monitoring while drilling. After the drilling work is completed, the complete recognition results are compared and analyzed together with the conclusions of the monitoring while drilling in this well, as shown in Table 9. It can be seen that the system recognition results are kept consistent with monitoring-while-drilling reports.

TABLE 9
Comparison of recognition results of a certain well

| | | Recognition | Recognition | | Recognition |
|---|---|---|---|---|---|
| | | results of | results of | Recognition | results of |
| | Conclusion of | formation gas | formation water | results of | picking up |
| Well depth | monitoring reports | production | production | sticking | stands |
| 5149.22 m | Formation gas | 97.25% | 1.71% | 0% | 0% |
| | production | | | | |
| 5173.06 m | Picking up stands | 0.14% | 1.58% | 0% | 99.44% |
| 5174.45 m | Formation gas | 99.34% | 1.78% | 0% | 0% |
| | production | | | | |
| 5133.018 m | Picking up stands | 0.96% | 2.61% | 0.02% | 99.98% |
| 5250.62 m | Formation gas | 98.80% | 46.13% | 99.92% | 0% |
| | production and sticking | | | | |
| 5251.64 m | Formation water | 3.48% | 85.34% | 2.22% | 0% |
| | production | | | | |
| 5254.58 m | Formation water | 4.15% | 83.54% | 0% | 0% |
| | production | | | | |
| 5254.69 m | Sticking | 1.52% | 29.02% | 96.54% | 0% |

According to the method of the present disclosure, a convolutional neural network structure that matches a monitoring data form of a current monitoring-while-drilling system and a training method thereof are designed based on the current status and actual needs of while-drilling safety risk monitoring. Safety risk features hidden among monitoring-while-drilling parameters can be efficiently acquired by using the convolutional neural network, and the accuracy of recognizing various while-drilling safety risks has reached more than 90%. In multiple field application tests of gas drilling while drilling, various while-drilling safety risks, such as formation gas production, formation water production and sticking can be sufficiently recognized. The recognition results are consistent with the judgment of the on-site monitoring personnel and a monitoring-while-drilling report after drilling, which proves that the present invention has a good recognition effect in the recognition of while-drilling safety risks. Compared with the traditional artificial judgment method, the on-site working conditions can be determined 2 to 3 minutes ahead, which can gain valuable time for the implementation of effective safety risk treatment measures. The on-site application test while drilling has proved that the convolutional neural network can acquire the mutual restriction and correlation among a plurality of monitoring-while-drilling parameters, and can extract the change features of a plurality monitoring-while-drilling parameters at the same time. Compared with the traditional BP Neural network, the convolutional neural network has obvious advantages in the field of feature extraction of monitoring-while-drilling data, and thus has an excellent application prospect in real-time recognition of while-drilling safety risks. Based on the convolutional neural network, according to the method of the present invention, the monitoring-while-drilling data can be directly used in combination with the trained network model for safety risk recognition, thereby realizing extremely-low-latency real-time monitoring, and overcoming the shortcomings of the previously used neural network system that cannot be efficiently recognized in real time. With the increase of sample data, the accuracy of recognizing more while-drilling safety risks in the present invention can be further optimized, and the generalization ability and anti-interference ability of the method can be improved. Meanwhile, since feature extraction and model training are performed in an autonomous learning manner, most of the data also comes from conventional drilling parameters. The method of the present invention also has good application prospects when being used for recognizing while-drilling safety risks for non-gas drilling, such as mud drilling, underbalanced drilling and other engineering.

The method of the present invention is applied to monitoring-while-drilling engineering, which can greatly improve the drilling efficiency and a reservoir drilling rate, reduce a complex accident rate and cost in drilling, provide a strong safety guarantee for drilling work, meet the current urgent demands for cost reduction and efficiency enhancement in drilling to a certain extent, and also provide a new idea for the development of intelligent drilling technologies in China.

The basic principles and main features of the present invention and the advantages of the present invention have been shown and described above. Those skilled in the art should understand that the present invention is not limited by the above-mentioned embodiments. The foregoing embodiments and descriptions described in the specification only illustrate the principle of the present invention. Without departing from the spirit and scope of the present invention, the present invention will have various changes and improvements, and these changes and improvements fall into the claimed invention. The protection scope of the present invention is defined by the appended claims and their equivalents.

1. An intelligent recognition method for while-drilling safety risks based on a convolutional neural network, comprising the following steps:
1: processing while-drilling safety risk parameter features and data, and establishing a correlation analysis model for monitoring-while-drilling parameters by using a Pearson coefficient correlation analysis method;
2: processing while-drilling safety monitoring data, analyzing a time span of each sample, constructing training sample data and test sample data, and preprocessing the samples;
3: designing a while-drilling safety risk recognition network structure, and training a network model; and
4: recognizing the while-drilling safety risks by the trained safety risk recognition network.

2. The intelligent recognition method for the while-drilling safety risks based on the convolutional neural network according to claim 1, wherein the step 1 specifically comprises the following sub-steps:
101: acquiring historical data of monitoring-while-drilling in multiple wells, initially screening out monitoring parameters that can reflect the changes in working conditions during the drilling process in a timely manner, and removing invalid or incorrect data;
102: further selecting a plurality of core parameters based on the importance of parameters in the monitoring-while-drilling process, to reduce the amount of subsequent data processing;
103: further classifying data sets in respective stages according to different stages of the drilling process; and
104: forming a macro law of changes in monitoring data corresponding to various safety risks by using an existing while-drilling safety risk theoretical model, and determining the composition of respective parameters in the most refined sample that characterizes various safety risk conditions in conjunction with Pearson parameter correlation analysis results.

3. The intelligent recognition method for the while-drilling safety risks based on the convolutional neural network according to claim 1, wherein the step 2 specifically comprises the following sub-steps:
201: constructing a plurality of sample data with different time spans for each while-drilling safety risk, performing while-drilling safety risk recognition training by using a plurality of networks at the same time, and performing a comparative experiment to ensure that the networks can not only contain most of the features of the while-drilling safety risks, but also reduce the system delay as much as possible; and meanwhile, performing offline analysis on drilling monitoring data, and constructing the training sample data and the test sample data;
202: preprocessing sample data by using few sample learning, processing the samples by using scaling, cropping, interpolation and SMOTE algorithms in data enhancement, and transferring a weight in a trained similar network by using a transfer learning algorithm to a new network with a certain correlation for training; and
203: normalizing a part of data that has too big difference in numerical value in the samples.

4. The intelligent recognition method for the while-drilling safety risks based on the convolutional neural network according to claim 3, wherein said processing the samples by using scaling, cropping, interpolation and SMOTE algorithms in data enhancement is specifically as follows: for a part of historical data with a large increase amplitude and obvious change features, a part of the data in the changing process can be extracted and expanded to the same time span by using data scaling and cropping to form a new training sample, and then the scaled data is filled to make it the same as an original sample by using a piecewise interpolation method; and after the data scaling and interpolation, fewer samples are analyzed by using a SMOTE algorithm, and a new sample is artificially synthesized based on the fewer samples and added to a data set.

5. The intelligent recognition method for the while-drilling safety risks based on the convolutional neural network according to claim 1, wherein the step 3 specifically comprises the following sub-steps:
301: performing feature extraction, i.e., pre-learning, on the sample data by using a convolutional layer, and then optimizing all network parameters by using a back-propagation algorithm; and
302: designing a network structure, which comprises an input layer, a convolutional layer 1, a convolutional layer 2, a hidden layer and an output layer; and performing a dimension reduction process on data before being inputted to a fully connected layer by using a principal component analysis method and by taking an elu function as an activation function.

6. The intelligent recognition method for the while-drilling safety risks based on the convolutional neural network according to claim 5, wherein the convolutional layer 1 is used to extract the changing trend of each parameter, and a one-dimensional longitudinal convolution kernel of m*1 is used to perform separate convolution calculations on n parameters respectively.

7. The intelligent recognition method for the while-drilling safety risks based on the convolutional neural network according to claim 5, wherein the convolutional layer 2 is used to extract a change relationship between parameters, and a one-dimensional transverse convolution kernel of 1*n is used to perform separate feature extraction on each row of a matrix.

8. The intelligent recognition method for the while-drilling safety risks based on the convolutional neural network according to claim 5, wherein the principal component analysis method aims to reduce a set of N-dimensional vectors to K-dimensional vectors, where 0<K<N, and the calculation process includes the following steps:
3021: normalizing each row of a variable matrix of a p*n order to form a new matrix X according to columns;
3022: solving a covariance matrix of the m-order matrix X;
3023: calculating feature values and corresponding feature vectors of the covariance matrix C;
3024: arranging the feature vectors from top to bottom in rows according to magnitudes of the corresponding feature values to form a matrix, and then taking their corresponding k feature vectors as column vectors respectively to form a feature vector matrix P; and
3025: multiplying the matrix X and the matrix P to acquire data after reduction to k dimension.

9. The intelligent recognition method for the while-drilling safety risks based on the convolutional neural network according to claim 5, wherein the number of nodes in the hidden layer is S=2x+1, where x is the number of nodes in the input layer; and the number of nodes in the hidden layer is S<N−1, where N is the number of network training samples.
